(19) United States
(12) Patent Application Publication
(10) Pub. No.: US 2009/0299713 A1
(43) Pub. Date: Dec. 3, 2009

(54) METHOD OF MODELLING THE EFFECT OF A FAULT ON THE BEHAVIOUR OF A SYSTEM

(75) Inventors: Peter John Miller, Bedfordshire (GB); Benjamin John Sewell, Cambridge (GB); Alejandro D. Dominguez-Garcia, Cambridge, MA (US)

Correspondence Address: OSHA LIANG L.L.P., TWO HOUSTON CENTER, 909 FANNIN, SUITE 3500, HOUSTON, TX, 77010, US

(73) Assignee: RICARDO UK LIMITED, West Sussex (GB)

(21) Appl. No.: 12/091,433

(22) PCT Filed: Oct. 23, 2006
(86) PCT No.: PCT/GB2006/003928

§ 371 Date: Jan. 15, 2009

(30) Foreign Application Priority Data
Oct. 24, 2005 (GB) 0521625.4

(51) Int. Cl. G06G 7/70; G06G 7/48

(52) U.S. Cl. 703/8; 706/46; 703/6

(57) ABSTRACT

A method of modelling the effect of a fault on the behaviour of a system. The method comprises modifying a functional model of a system to specify a fault in the system; running the model in accordance with a test, the test having an input and an expected output, the input defining the value of a least one input variable over a period of time and the expected output defining the expected value of at least one output variable over the period of time; the functional model calculating, in dependence on the value of the input variable defined by the input, a modelled output comprising the modelled value of the output variable over the period of time; and comparing the modelled output with the expected output to determine a severity score for the fault based on the difference between the modelled output and the expected output.

This invention relates to a method of modelling the effect of a fault on the behaviour of a system, in particular a system which models an engineering design such as a vehicle system.

For safety critical systems, for example in the automotive industry, reliability reports are created manually. Reliability reports are generated from reliability and safety analyses such as an FMECA (Failure Modes, Effects and Criticality Analysis) or an FMEA (Failure Modes and Effects Analysis).

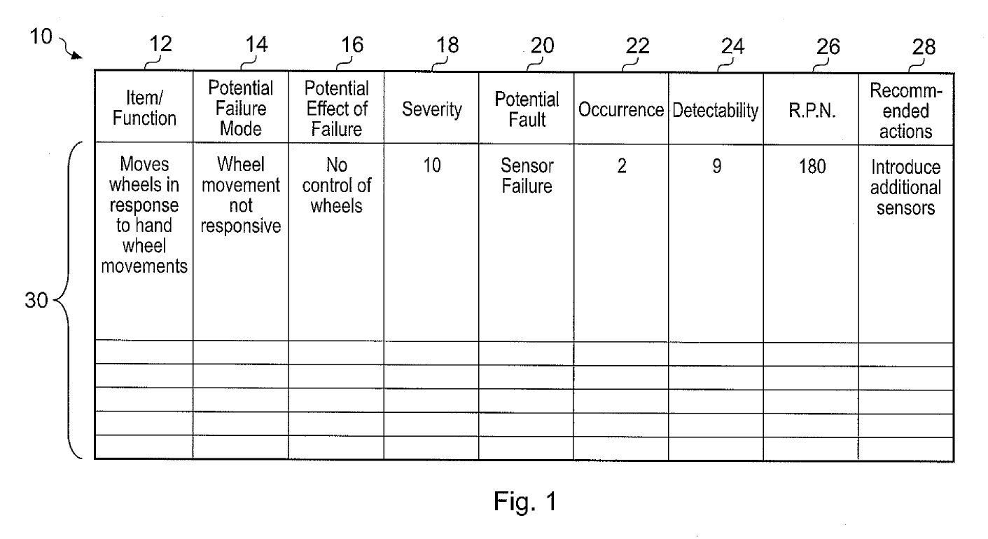

An example of a reliability report is shown as report or table 10 in FIG. 1. Only one of rows 30 has been filled in FIG. 1, although it should be noted that in a real reliability report multiple rows would be completed. The example in FIG. 1 relates to a vehicle steering system. The whole of report 10 is created manually and relies on the subjective judgement of an engineer or a team of engineers to assert the effects of a component failure on the system and to quantify the severity of this effect

Referring to FIGURE, 1 in column 12 the function of the steering system is defined as “moves wheels in response to hand wheel movements”. In column 14 the potential failure mode is defined. Here this is defined as “wheel movement not responsive” indicating that the wheel (steering rack) movement is not responsive to the hand wheel movement. In column 16, the potential effect of this failure is defined as “no control of wheels”. In column 18, a severity score for the potential effect is defined. The severity score is typically a value between 0 and 10 (a low score representing low severity) and in this example the severity score of 10 (indicating a very severe effect) has been given.

In column 20 the potential fault is listed as “sensor failure” and in column 22 an occurrence score of between 1 and 10 is given for this potential fault (a low score representing low occurrence). In the example an occurrence score of 2 has been given.

In column 24 the detectability of this potential fault is defined. Here the detectability score of 9 has been given to the potential fault. This score is again a score between 1 and 10, although in this instance a high score indicates low detectability.

In column 26 the risk priority number (RPN) is calculated by multiplying the severity score by the occurrence score by the detectability score. If the RPN is above a certain value, for example if it is above 80, and optionally if the severity score is above a certain value, for example if the severity score is above 7, then the engineer(s) populate the table further by recommending further actions. This may include modifications to the system and may include further project based targets such as a completion date for an action. Other columns may be included in the report for various comments that the engineer(s) may wish to make and to record other information such as recording when recommended actions have been performed.

For any system such as a vehicle steering system or a heating, ventilation and air conditioning (HVAC) system, multiple functions are typically defined in the failure report. For each function, several potential failure modes are typically identified by the engineer(s) and for each potential failure mode multiple potential effects of failure may be identified. For each potential effect of failure there may be multiple potential faults.

It will be appreciated that reliability reports are typically large. They are created manually and they rely on the subjective judgement of engineer(s). Constructing a reliability report takes considerable time and typically requires engineer-input throughout. Moreover, any changes to the system may invalidate an entire report meaning that a fresh report needs to be created. Again, the recreation of a reliability report following the change of a system is time consuming. Furthermore, the subjective assessment, particularly as far as giving a severity score to a potential effect of failure lacks rigorous quantification and is therefore unreliable.

Furthermore, the typical analysis contained within a reliability report is based on an analysis of the effect of a single fault. An assessment of the potential effect of multiple faults within a system is not typically studied in a typical reliability analysis. This is unrealistic and may mean significant multiple faults are not identified.

A paper published in Conferences in Research and Practice in Information Technology, Vol. 38, Australian Computer Society, 2004, entitled “A Method and Tool Support for Model-based Semi-automated Failure Modes and Effects Analysis of Engineering Designs” describes a tool that requires the engineer to annotate Matlab/Simulink or ITI/SimulationX models. These annotations effectively describe mini fault trees for each component in the model. The tool then assembles these mini fault trees into a set of system fault trees by assuming that faults propagate along signal lines in the model. It then produces a FMEA based on the system fault trees.

The invention is set out in the accompanying claims.

A method of modelling the effect of a fault on the behaviour of a system is therefore provided. In particular, a method of determining a severity score for use in reliability reports is provided, enabling engineer-input to be focussed at an efficient level.

By using a functional model, additional and separate coding of the input and output variables are not required since the functional model calculates and models these variables. Also, engineer-input is not required to produce the whole reliability report. Rather engineer-input is required for only certain definitions which are then used as inputs for the method. Embodiments of the present invention therefore provide significant time savings over known approaches for constructing a reliability report for a system. The time savings are both in overall terms—reports can be created in a day or so rather than months or years—as well as in terms of the proportion of engineer time required.

Furthermore, if the functional model is changed, for example following the analysis of an earlier reliability report, then a fresh engineer-generated report does not have to be produced. Nor does a separate reliability model have to be changed to reflect changes to the functional model. This is because the variables calculated within the changed functional model will automatically reflect the changes made to the model itself and these variables are used in the method of the present invention. Accordingly, embodiments of the present invention provide extremely significant time savings over known approaches when producing further reports after the system has been changed.

An embodiment of the present invention will now be described, by way of example only, with reference to the accompanying drawings, in which:

FIG. 1 is an illustrative example of a known reliability report;

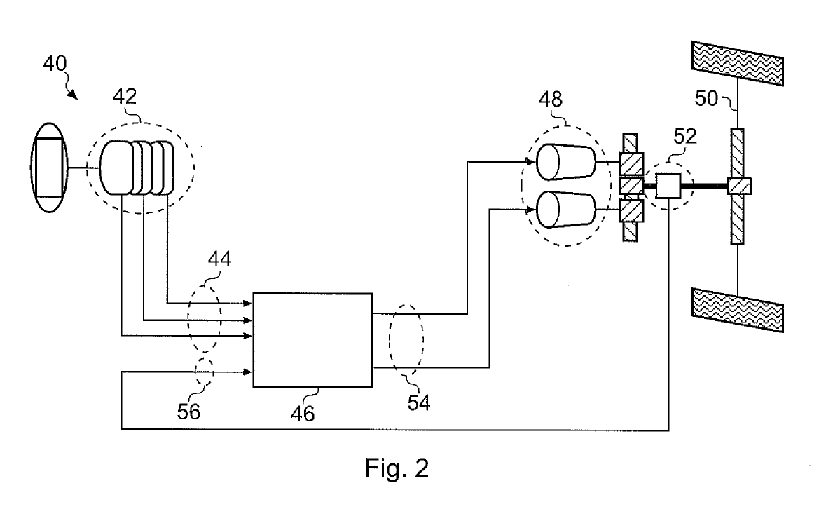

FIG. 2 is an illustrative example of a functional model of steer-by-wire system;

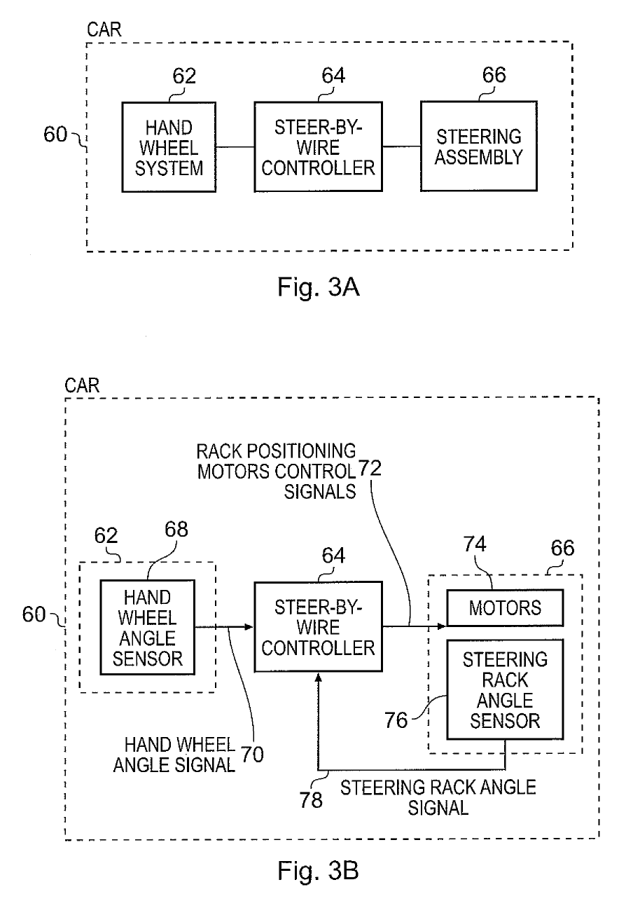

FIGS. 3A and 3B show a simplified illustration of the functional model of FIG. 2;

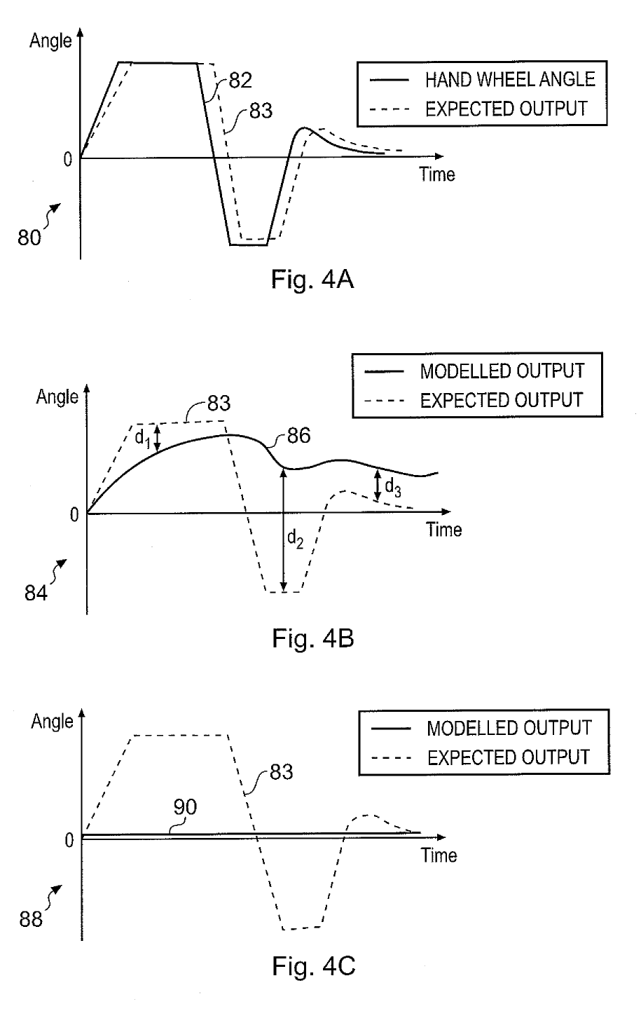

FIG. 4A illustrates an input (hand wheel angle) and an expected output (steering rack angle) for an example test;

FIGS. 4B and 4C illustrate examples of a modelled output for the test of FIG. 4A;

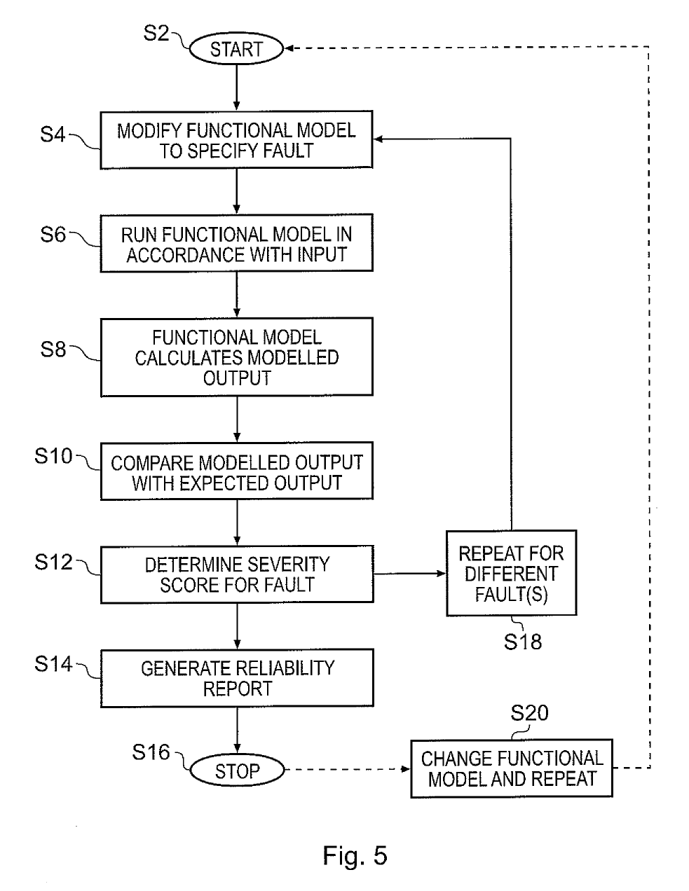

FIG. 5 illustrates the operational steps of a method in accordance with an embodiment of the present invention;

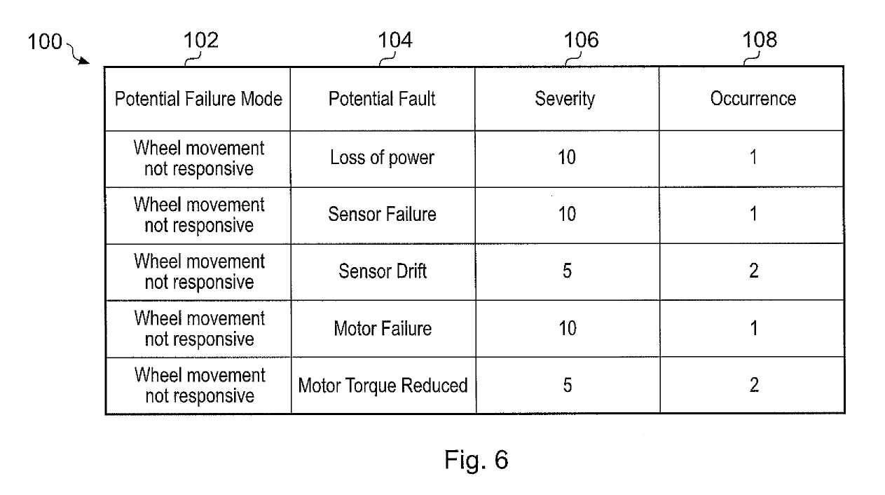

FIG. 6 illustrates a reliability report generated by a method in accordance with an embodiment of the present invention; and

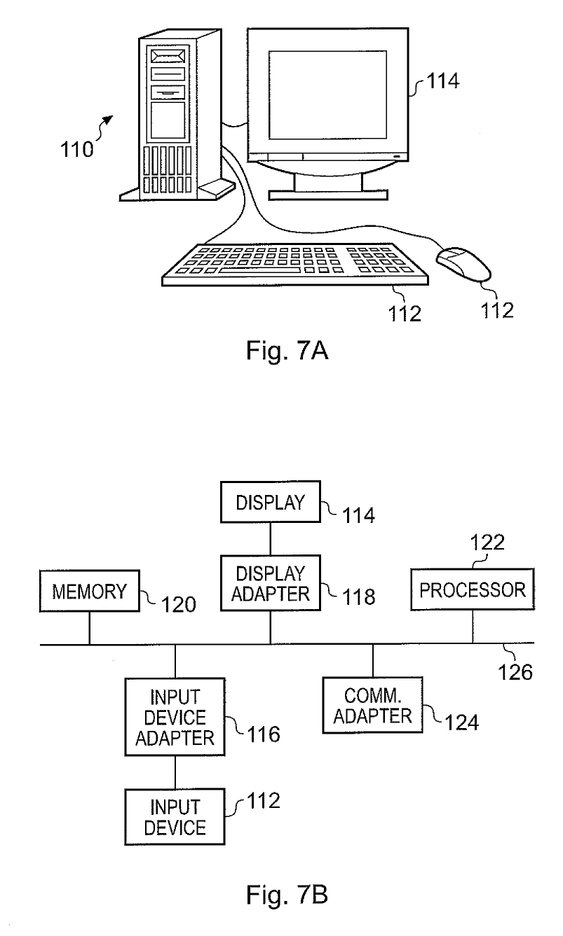

FIGS. 7A and 7B illustrate a computer which can be configured to perform the method of an embodiment of the present invention.

The present invention relates to a method of modelling the effect of a fault on the behaviour of a system. A functional model (e.g., a Matlab/Simulink or ITI/SimulationX model) is used to model a system, typically a system which models an engineering design such as a vehicle system. Such models calculate and model the values of various variables within the system. For example in a functional model of a conceptual steer-by-wire architecture, the following variables may be calculated and modelled by the model: the hand wheel angle, the hand wheel angle signal, the rack positioning motor control signal, the steering rack angle and the steering rack angle signal.

A fault (e.g., sensor failure) is defined, by setting a modifier to modify the functional model (e.g. by modifying one or more variables within the model). For example, for a sensor failure fault the output of the sensor rather than indicating the sensed value can be set to zero indicating that there is no output from the sensor. This fault is injected into the model by modifying the variable value within the model (i.e. setting the value to zero).

A test is defined which specifies the value of at least one input variable (e.g. hand wheel angle) over a period of time. A test may be considered as representing a potential operating mode of the system. An output comprising at least one output variable (e.g. steering rack angle) is also defined. An expected output value for the test is defined which specifies the expected value of the output variable over the period of time. The expected output can be the output produced by the model when no fault is injected.

The output and corresponding expected output can be defined to correspond to a potential failure mode of the system, so that the test can be used to analyse the effect of a fault for a particular failure mode.

The fault is injected into the model and the model is run in accordance with the test. The model calculates the modelled output. The output from the functional model is compared with the expected output to determine a severity score for the fault based on the difference between the modelled output and the expected output.

With reference to FIG. 1, embodiments of the present invention provide an approach to determining the severity score illustrated in column 18 of FIG. 1. Occurrence and detectability values (22 and 24, FIG. 1) and the RPN (26, FIG. 1) can be calculated in the same way as known approaches.

Referring to FIG. 2 an illustrative depiction of a functional model of a system is shown. In this example a steer-by-wire system 40 for a vehicle is shown. Hand wheel angle sensors 42 are illustrated. These sensors detect the angle of the hand wheel (i.e., the steering wheel). In the example shown in FIG. 2, three hand wheel sensors 42 are depicted. Providing three such sensors is a common approach to provide redundancy since hand wheel sensor failure has the potential to be extremely severe. Accordingly, three hand wheel angle signals 44 are sent from hand wheel angle sensors 42 to the steer-by-wire controller 46. The path of these three hand wheel angle signals 44 is depicted by the three arrows extending from hand wheel sensors 42 to controller 46 in the FIGURE.

The system 40 has two rack-positioning motors 48 which are connected to the steering rack assembly 50. A steering rack angle sensor 52 is shown between the angle positioning motors 48 and the steering rack assembly 50 in the model. Two rack-positioning motor control signals 54, one for each of the two rack-positioning motors 48, are sent from steer-by-wire controller 46 to the rack positioning motors. These control signals 54 are depicted by the two arrows (one for each signal) extending from the controller 46 to the motors 48 in the FIGURE.

The steering-rack angle sensor 52 senses the angle of the steering rack and sends a steering-rack angle signal 56 to the controller 46. The steering-rack angle signal 56 is depicted by arrow 56 extending from angle sensor 52 to controller 46 in the FIGURE.

FIG. 2 has been given for illustrative purposes. Functional model tools (e.g., Simulink) typically provide a graphical block diagram language which allows functional models to be written in a modular, hierarchical format. Groups of components are separated into hierarchical levels; the top layer showing the least detail and each succeeding level revealing more detail of each sub-system or component. The skilled person will be familiar with such models.

FIGS. 3A and 3B illustrate the steer-by-wire system of FIG. 2 in a more conventional functional modelling depiction and in simplified form.

Referring to FIG. 3A, the uppermost or root level of the system is shown. In the illustrated system, the car 60 comprises a hand wheel system or sub-system 62, a steer-by-wire controller 64 and a steering assembly 66. Typically such sub-systems 62, 64 and 66 are supported and provided by libraries within the functional model tool, although sub-systems can be defined by the user.

FIG. 3B illustrates the sub-systems in further detail. Within the band wheel system 62, a hand wheel angle sensor 68 is provided. Hand wheel angle signal 70 flows from the hand wheel angle sensor 68 to the steer-by-wire controller 64. The hand wheel angle is depicted by arrow 70 in the FIGURE.

Rack positioning motor control signals (arrows 72 in the FIGURE) are transmitted from the controller 64 to the motors 74 within the steering assembly 66. The steering assembly 66 also comprises a steering rack angle sensor 76 from which a steering rack angle signal (arrow 78 in the FIGURE) is transmitted back to the controller 64.

It will be appreciated that the system illustrated in FIGS. 3A and 3B is a simplification of the system of FIG. 2. In particular the presence of the three hand wheel angle sensors has been replaced by a single hand wheel angle sensor 68 for reasons of simplicity.

Within a functional model various system variables are defined. In the example of FIG. 3B the system variables include the hand wheel angle, the hand wheel angle signal 70, the rack positioning motor control signal 72, the steering rack angle and the steering rack angle signal 78.

Faults may be defined for the system that is represented by the functional model. Examples of faults for the illustrated system are: (i) a loss of power (engine failure); (ii) sensor failure; (iii) sensor drift; (iv) motor failure; and (v) reduced motor torque. A fault is represented by a modifier which modifies the functional model to represent the fault. Depending upon the particular fault, a modifier can set a variable within the model to a fixed value, multiply a variable by a constant or otherwise change the functional model so that it represents the behaviour of the system with the fault present (e.g. apply a function to a variable within the model). For example, (i) a loss of power can be represented by a modifier which sets the torque variable for the motor to zero; (ii) sensor failure can be represented by a modifier which sets the hand wheel angle signal variable to zero; (iii) sensor drift can be represented by a modifier function which defines a drift which is applied to the hand wheel angle signal variable (e.g., a function to add an additional 10% to the value every hour); (iv) motor failure can be represented by a modifier which sets the torque variable for the motor to zero; and (v) reduced motor torque can be represented by a modifier which multiplies the torque variable by a number (e.g. 0.8). As a further example, a short circuit within a motor can be represented by changing the functional model so that instead of the motor producing an output torque as a function of its input current, it produces a (negative) torque depending upon the speed of rotation of its input shaft.

These faults or fault definitions can be defined by engineer(s) and can be stored outside the model (normally in a suitable database), with the model being annotated to show which faults can apply to which sub-system or component and to show the corresponding occurrence rate for the fault. Again, advantageously, engineer-input is focused at the level where engineer experience is required.

In a particular embodiment, the fault or fault definition is predefined in a functional model library. Sub-systems and components are stored within the library with the sub-systems and components annotated with the fault definition, and optionally the occurence rate. Accordingly, the act of using the sub-system or component within the model automatically creates a model containing the annotations showing the faults. Advantageously, the user can construct the model in the usual manner.

Any number of faults can be defined in embodiments of the present invention.

For each fault an occurrence rate can also be defined in the model. The occurrence rate represents the expected rate at which the fault will occur. Occurrence rates for particular components can be found from known sources such as component reliability databases, e.g. MIL std 217, or can be engineer-defined for a particular component if required.

In the five example faults given above the occurrence rates are (i) 1e-9/hr; (ii) 1e-7.hr; (iii) 1e-6/hr; (iv) 1e-6/hr; and (v) 1e-8/hr. Occurrence rates can optionally be defined in other terms. For example these can be defined as the likely failure rates over the design life.

As mentioned above, the occurrence rates can also be stored separately or in the functional model as annotations. Annotations are comments that typically do not directly impact the normal operation of the model, but which can be viewed an changed by a user (engineer) creating a model.

As well as faults being defined, tests are also defined. A test has an input which defines the value of an input variable over a period of time. The input variable can be any variable modelled within the functional model. A test may either reflect a normal operating mode of the system (e.g. driving around a predefined set of roads at predefined speeds) or may be designed to highlight certain types of failure modes. For example, for an example failure mode of “wheel movement not responsive” (c.f. column 14 of FIG. 1), how a predefined set of hand wheel angles changes with time can be used as a suitable input.

The test also has an expected output. The expected output defines the expected value of an output variable over the period of time. Again, any variable modelled within the functional model can be used, although a suitable output variable should be selected. The expected output can be defined to correspond to a potential failure mode of the system, so that the test can be used to analyse the effect of a fault for a particular failure mode. For example, steering rack angle can be used as a suitable output variable for the example failure mode.

One or more input variables may be defined in the input. Similarly, one or more output variables may defined in the output.

FIG. 4A shows a graph 80 which illustrates an example test for the example failure mode. The hand wheel angle 82 (plotted as a continuous line) is shown and the expected output 83, in this example the steering rack angle, is plotted as a dashed line. As can be seen in the Figure, the expected output follows just behind the input as the input rises from zero, plateaus at a positive value, falls, plateaus at a negative value, rises again to a positive value and tails off to zero.

The expected output can be produced by the functional model by running the model in accordance with the input, without any faults having been injected into the system (i.e., without modifying any variable in the model to specify a fault).

A test can be stored as part of the model, within a separate program or in a database of tests.

Any number of tests can be defined in embodiments of the present invention. Typically, multiple tests are defined each associated with one or more faults.

A test is associated with a set of performance levels. Performance levels can be defined globally for multiple tests (e.g. for all tests or a subset of tests) or on a test-specific basis.

Engineer-input is usually required initially to define performance levels, although once the performance levels have been defined future engineer-input for defining performance levels is not required Again, advantageously engineer-input is focussed at the level where engineer experience is required.

A set of performance levels are defined. Each performance level has an associated severity score. The severity scores can range from a minimum value (typically zero) to a maximum value (typically 10). The severity score represents the potential effect of a fault. A severity score of zero means the system is operating within its specification (e.g. a system with no faults should always give a severity score of zero and this can be used to check the system meets its requirements). A severity score at the lower end of the range (e.g. 1-3) represents a lower severity effect for the fault; a severity score in the middle of the range (e.g. 4-6) represents medium severity; and higher values (e.g. 7-10) represent high severity, 10 being the highest severity score.

Each performance level defines a relationship between the modelled output and the expected output. The modelled output is the output from the functional model when a fault has been injected into the model (i.e. the model has been modified to represent the fault) and the model has been run in accordance with a test.

For example, three performance levels can be defined, in general terms, as (i) “in specification performance”; (ii) “fair performance”; and (iii) “poor performance”, each having an associated severity score (e.g. 0, 5 and 10 respectively). In other examples a different number of performance levels can be defined.

The relationship between the modelled output and the expected output for these performance levels could be (i) in specification, up to 1% deviation; (ii) between 1% and 5% deviation; (iii) equal to or greater than 5% deviation.

Functional model tools are sophisticated tools and in certain tools (e.g. Carsim) performance levels can be set in such terms as “stays in lane”; “stays on road”; and “off road”. Such definitions of performance level can be used and a severity score associated with each.

By allowing performance levels to be defined, this enables engineers to focus on what is and is not an acceptable level of performance and to set subjective severity scores accordingly. Whilst the severity score ascribed to a particular performance level is subjective, once it has been set there is no subjective input from the engineers as to what the severity score should be for a particular failure mode, as required in known approaches.

A severity score may be produced without using performance levels, for example the score could be directly related to the relationship between the expected output and modelled output, for example by a function which produces a weighted result of between 0 and 10.

FIG. 5 shows the operational steps of a method in accordance with an embodiment of the invention. Typically before the method begins, the fault(s), test(s), performance levels and associated severity scores have been pre-defined as described above.

The process begins at step S2. A fault is then injected into the model. The fault (e.g. sensor failure) is represented by a predefined modification to the system (e.g. to set the hand wheel angle to zero). Accordingly, at step S4 the fault is injected by modifying the functional model to specify the fault. In some embodiments, multiple faults can be injected by making multiple modifications to the model. Generally, multiple faults are not considered in an FMEA. Accordingly, the ability to inject multiple faults is a significant advantage provided by such embodiments.

At step S6 the functional model is run in accordance with an input (e.g. the hand wheel angle of FIG. 4A) which is specified by a test. The input defines the value of an input variable over a period of time (e.g. 30 mins, 1 hour, 2 hours).

In some embodiments, multiple runs of the model with multiple tests may be performed.

At step S8 the functional model calculates, in dependence on the value of the input variable defined by the input, a modelled output. The modelled output comprises the value of the output variable (as calculated by the model) over the period of time.

FIG. 4B illustrates an example graph 84 showing a modelled output 86 (shown as a continuous line). The expected output 83 is also illustrated (as a dashed line) in this example the input and expected output are as described for FIG. 4A. The expected output is the expected steering rack angle and the modelled output in the modelled steering rack angle. This example is for a “sensor drift” fault.

It should be noted that a graph is used for illustrative purposes. The input, expected output and modelled output may be stored in any other suitable form, e.g. as tables.

At step S10 the modelled output is compared with the expected output to determine a severity score at step S12. Performance levels may be used to determine the severity score.

To determine the performance level the deviation or difference between the modelled output and expected output can be calculated in any suitable way, for example by comparing instantaneous values or by integrating the difference between the modelled output and expected output.

For example the difference between the modelled output and expected output in FIG. 4B (illustrated at three arbitrary points as d1, d2 and d3) may be determined at set points such as those illustrated. An average difference can be calculated as a percentage to determine an average percentage difference. Using the earlier example, if the average percentage difference is a “1% to 5% deviation” then this indicates a “fair performance” and a severity score of 5 is ascribed to the fault.

In a particular embodiment, a model of a whole vehicle system (e.g. an automobile system) is used. In such a model failure classification (e.g. as performance levels) can be described in easily understood terms. The terms may also be re-useable. For example, if a modelled vehicle goes outside its lane but stays on the correct side of the road during a specified manoeuvre then a severity score of 5 may be appropriate.

FIG. 4C illustrates another graph showing another example modelled output 90 (a continuous line at angle equals zero). The expected output 83 is also shown on the graph as a dashed line. The fault modelled for FIG. 4C is a “sensor failure” which has resulted in the hand wheel angle not being detected and a value zero being calculated by the functional model for the steering rack angle (based on a value of zero for the hand wheel angle signal produced by the failed sensor). Again using the earlier example, the performance level for this example is a “greater than 5% deviation” and a severity score of 10 is ascribed to the fault.

Optionally steps S4 to S12 are repeated for different faults as shown by step S18.

At step S14 a reliability report is generated. An example reliability report is shown in FIG. 6 as table 100.

Referring to FIG. 6, the potential failure mode 102 is defined by the test. In this example the potential failure mode is “wheel movement not responsive”.

The table 100 also contains the potential faults 104 for the potential failure mode. These are the five example faults which have already been described i.e. (i) loss of power; (ii) sensor failure; (iii) sensor drift; (iv) motor failure; and (v) motor torque reduced.

The severity scores which have been calculated in accordance with the described method are populated in column 106.

The occurrence column can be populated from the occurrence rate information (e.g in the form of a rate as 1e-9/hr or in the form of information defining the likely failure rate of a component over its design life) by converting this to an occurrence score of between 1 and 10. The conversion can be performed by a conversion table or other suitable technique. An example of a conversion table follows:

| Likely Failure Rates Over Design Life | | Occurance score |
|---|---|---|
| ≧100 | per thousand vehicles/items | 10 |
| 50 | per thousand vehicles/items | 9 |
| 20 | per thousand vehicles/items | 8 |
| 10 | per thousand vehicles/items | 7 |
| 5 | per thousand vehicles/items | 6 |
| 2 | per thousand vehicles/items | 5 |
| 1 | per thousand vehicles/items | 4 |
| 0.5 | per thousand vehicles/items | 3 |
| 0.1 | per thousand vehicles/items | 2 |
| ≦0.01 | per thousand vehicles/items | 1 |

Accordingly, occurrence rates can be grouped into 10 predefined bands. Each band can be associated with a corresponding occurrence score. The band corresponding to occurrence score 10 being the least reliable and the band corresponding to occurrence score 1 being the most reliable.

Also, detectability values of between 1 and 10 can be determined, for example by reference to the production process information for a component. As an example, if a certain fault is detectable during the production process (for example if a component will break under full load) then if a full load test is present in the production process and was guaranteed to be applied to all parts manufactured the detectability could be set to 1. Alternatively, if no test at all was present during the production process the detectability could be set to 10. Some faults can also be monitored during normal operation (for example in FIG. 3B a component could be added to check that the hand wheel angle signal was approximately equal to the steering rack angle signal). In many cases where detectability measures are not present, or not a required part of the analysis, then either this column can be omitted, or all the detectability values set to 1. It should be noted that risk mitigation features such as redundancy (e.g. providing multiple equivalent components as a contingency) will automatically be taken account of in the process described herein without the need to use detectability values. This is because the redundancy will be modelled in the functional model.

Accordingly a failure report with severity, occurrence, detectability and RPN can be generated.

Referring to FIG. 5, step S20 is also shown. Step S20 shows that once a reliability report has been generated the model of the system can be changed. This change will be made to the functional model. For example, one or more additional hand wheel angle sensors could be included. Such a change will invalidate the failure report since the severity scores will change, for example the severity score for a single sensor failure will be less. Accordingly, a new reliability report will need to be generated.

In known approaches generating a new reliability report would involve engineers reproducing a reliability report, or at least would involve updating a separate reliability model to reflect the change. This requires significant effort and engineer input. However, in the described method since the functional model calculates the modelled output, the change is automatically reflected. Advantageously, following a change in the model steps S2 to S16 can be re-run without any additional input from engineers. This can reduce the time in which a failure report can be re-run from weeks or months down to less than a day.

It will be appreciated that step S8 is performed by the functional model. The functional model can be configured to perform any one or more of steps S4, S6, S10, S12 and S14.

For example a fault definition can be made in the functional model, the fault definition being activatable to perform step S4. This can be achieved by defining additional variables in the model which when set to true inject a specified fault (or test). When set to false the model operates as if the fault (or test) is not present. These variables can then be used to set the faults (or tests) as required, either manually or automatically.

Optionally steps S4, S6, S10, S12 and S14 may be performed by a computer program. For example, a computer program can read annotations (comments) in the functional model to specify faults and tests and to selectively inject the faults and run the tests. Alternatively, the computer program may use a separate input file.

Any suitable functional model may be used in the present invention. Particularly suitable model tasks include Matlab/Simulink from The MathsWorks, Inc (www.mathworks.com), ITI/SimulationX from ITI GmbH (www.simulationx.com), Carsim from Mechanical Simulation Corporation (www.carsim.com) is a particularly suitable task for functional modelling of car systems.

FIGS. 7A and 7B show an apparatus which can be configured to perform the method of the present invention. The apparatus is in the form of a computer 110. FIG. 7A shows an external view of the computer and FIG. 7B is a schematic and simplified representation of the computer components.

The computer 110 comprises various data processing resources such as a processor 122 coupled to a bus structure 126. Also connected to the bus structure 126 are further data processing resources such as memory 120. A display adapter 118 connects a display 114 to the bus structure 126. A user-input device adapter 116 connects a user-input device 112 to the bus structure 54. A communications adapter 124 may also be provided to communicate with other computers, for example across a computer network.

In operation the processor 122 will execute instructions that may be stored in memory 120. The results of the processing performed may be displayed to a user via the display adapter 118 and display device 114. User inputs for controlling the operation of the computer 110 may be received via the user-input device adapter 116 from the user-input device 112.

It will be appreciated that the architecture of the apparatus or computer could vary considerably and FIGS. 7A and 7B illustrate just one example.

A computer program operable to cause a computer such as computer 110 to perform the method of the present invention can be written in a variety of different computer languages and can be supplied on a carrier medium (e.g. a carrier disk or carrier signal).

Although the invention has been described with reference to a particular example, variations are within the scope of the invention.

For example, although the example of a steer-by-wire vehicle system has been used as a particular example of an embodiment of the invention, it will be appreciated that the method of the present invention can be used with other systems which can be modelled in a functional model, in particular systems which model an engineering design. Such systems may include automotive (e.g. vehicle systems such as automobile systems), aerospace and other safety critical systems. The method of the present invention is particularly applicable to systems in which reliability reports are generally used. Examples include automotive engineering, power transmission and control systems, fluid power plants, and thermics applications.

As another example, rather than injecting one fault at a time, all possible combinations of faults may be injected at once; or a fixed number of faults may be injected. Optionally, multiple faults may be injected until a fault of defined severity is found (for example until vehicle stops, or is uncontrollable). In the case where multiple faults are simultaneously present the occurrence score may be based on the combined probabilities of failures of each of the individual faults. This calculation may be preformed by using a Markov reliability model or analysis or similar techniques as are well known to people skilled in the art. In particular if a Markov reliability analysis is used then the calculated reliability can be based on the stress on the component or sub-system during the test (this stress may come from normal use, or may be a function of other failures, for example in FIG. 2 the when one motor fails the stress on the second motor is likely to increase which would reduce its reliability).

As a further example, the result of the method may be presented in a number of different ways. For example, as an FMECA, a Markov reliability model or as fault (or success) trees.

Embodiments of the present invention can provide refined, quantifiable and repeatable severity scores for potential faults within the system. Furthermore, since the functional model is used to produce a severity score, the system modelled in the functional model can be changed and the tests can be automatically repeated meaning that further engineering-input is not required to determine the severity of a potential fault after a system change, whereas in prior approaches engineering-input would be required. Furthermore, the use of quantified tests, performance levels and faults reduces the subjectivity of the assessment.

1. A method of modelling the effect of a fault on the behaviour of a system, comprising:
(a) providing variable in a functional model of a system, wherein setting a variable to true injects a specified fault and wherein setting the variable to false causes the model to operate as if the fault is not present;
(b) setting a variable to true to modify the functional model to specify a fault in the system;
(c) running the functional model in accordance with a test, the test having an input and an expected output, the input defining the value of at least one input variable over a period of time and the expected output defining the expected value of at least one output variable over the period of time;
(d) the functional model calculating, in dependence on the value of the input variable defined by the input, a modelled output comprising the modelled value of the at least one output variable over the period of time; and
(e) comparing the modelled output with the expected output to determine a severity score for the fault based on the difference between the modelled output and the expected output.

2. A method according to claim 1, wherein step (b) comprises setting two or more variable to true to make two or more modifications to the functional model to specify two or more respective faults in the system.

3. A method according to claim 1, wherein step (e) comprises comparing the modelled output with the expected output to determine a performance level for the fault and converting the performance level to the severity score for the fault.

4. A method according to claim 3 wherein there are a predefined set of performance levels and each performance level of the set has a corresponding predefined severity score.

5. A method according to claim 1 further comprising repeating steps (b) to (e) for different faults in the system.

6. A method according to claim 1, further comprising determining an occurrence score for the fault by converting failure data into the occurrence score.

7. A method according to claim 1, further comprising determining an occurrence score for a combination of two or more faults by using a Markov reliability analysis.

8. A method according to claim 1, further comprising:
(f) generating a reliability report comprising the severity score for one or more faults.

9. A method according to claim 1, further comprising making a fault definition in the functional model, the fault definition being activatable to perform step (b).

10. A method according to claim 9, wherein the fault definition is predefined in a functional model library.

11. A method according to claim 1, wherein the model is a vehicle model.

12. A method according to claim 1, wherein the model is an automobile model.

13. A method according to claim 1, further comprising changing the model and repeating the steps (a)-(e).

14. A method according to claim 1 wherein the model is a Simulink model.

15. A method according to claim 1 wherein the model is a Carsim model.

16. A computer program operable to cause a computer to perform the method of claim 1.

17. A carrier medium comprising the computer program of claim 17.

18. A computer configured to perform the method of claim 1.

19. An apparatus comprising a processor configured to perform the method of claim 1.
